(19) United States
(12) Patent Application Publication
(10) Pub. No.: US 2025/0187820 A1
(43) Pub. Date: Jun. 12, 2025

(54) IMPROVED WASTE HANDLING SYSTEMS

(71) Applicant: Scott Joseph Frybarger, Brandenton, FL (US)

(72) Inventor: Scott Joseph Frybarger, Brandenton, FL (US)

(21) Appl. No.: 18/978,162

(22) Filed: Dec. 12, 2024

Related U.S. Application Data
(60) Provisional application No. 63/609,046, filed on Dec. 12, 2023.

(51) Int. Cl. B65F 1/14; B65F 1/12; B65F 3/04

(52) U.S. Cl. CPC B65F 1/1405; B65F 1/122; B65F 1/1468; B65F 3/041; B65F 2210/139; B65F 2210/1443; B65F 2210/172

(57) ABSTRACT

Described in a system and method for waste handling. The system comprises a compressing collection bin comprising a cavity and a compression platen in the cavity positioned to move within the cavity to compress waste contained therein during a compression stroke. An actuator moves the compression platen within the cavity in at least one motion selected from perpendicular motion and differential velocity. An energy storage device powers actuator and a solar panel for charges the energy storage device. At least one lift channel is provided which is capable of engaging with inversion fingers.

### CROSS-REFERENCE TO RELATED APPLICATIONS

The present application claims priority to pending U.S. Pat. Appl. No. 63/609,046 filed Dec. 12, 2023 which is incorporated herein by reference.

### FIELD OF THE INVENTION

The present invention is related to the field of waste handling. More specifically, the present invention is related to an improved system of collecting, storing, compressing and transporting waste, particularly solid waste, utilizing solar energy and improved compaction methods and compressing collection bins related thereto.

### BACKGROUND

Waste handling is a large, and necessary, business globally. The particular segment of waste handling addressed herein is that portion of the waste handling business related to the collection of waste in a collection bin, also commonly referred to in the art as a dumpster, wherein the waste in the collection bin is transferred to a transport vehicle, such as a hauler or loader, wherein the transport vehicle lifts the collection bin and inverts the collection bin over a collection area, or hopper, of the transport vehicle to transfer the components of the collection bin to the collection area of the truck.

The art of waste handling is well advanced. In spite of the maturity of the art there are still significant inefficiencies associated with commonly employed methods of waste handling. Without limit thereto, the primary inefficiencies addressed herein are cycle time between transfer of the trash to a transport vehicle and available volume of the collection bin.

Cycle time is defined herein as the amount of time between sequential transfer operations from the collection bin to the transport vehicle. A longer cycle time, or fewer visits in a period of time, improves efficiency and reduces cost. A primary detriment to cycle time improvements is the transfer of partial collection bin volumes. This is often the result of a pre-determined cycle time, such as a weekly scheduled transfer, or poor volume usage of the collection bin wherein the collection bin appears full however there is unused volume remaining.

There have been many efforts associated with inefficient cycle time. One common solution to an inefficient cycle time is a compaction process wherein the waste is compacted such as by pressure. While beneficial, the compaction systems known in the art occupy a large volume of space which either limits the available volume of the collection bin, which is counter-productive, or requires additional space beyond that which the collection bin would otherwise occupy which is not always practical. The dimensions of a collection bin are defined to be sufficient for handling by a transport vehicle and therefore the designer has limited flexibility in collection bin sizes. Conventional compaction systems typically utilize linear rams of some form, such as hydraulic rams, to compact the trash. Linear rams, particularly linear hydraulic rams, which require significant space since the cylinder and ram must be aligned and upon retraction the length of the ram and cylinder is at least as long as the compaction length. The compaction devices also require power which is a limit in many applications.

Provided herein is a significantly improved system, and improved compressing collection bin associated therewith, for waste handling.

### SUMMARY OF THE INVENTION

The invention is related to an improved system for handling waste.

A particular feature of the invention is a compressing collection bin which has a compression function for compressing waste contained within the compressing collection bin volume while occupying limited space.

Yet another particular feature is the maximization of usable volume, within the compressing collection bin, due to orientation of the actuator and controls.

These and other embodiments, as will be realized, are provided in a system for waste handling. The system comprises a compressing collection bin comprising a cavity and a compression platen in the cavity positioned to move within the cavity to compress waste contained therein during a compression stroke. An actuator moves the compression platen within the cavity in at least one motion selected from perpendicular motion and differential velocity. An energy storage device powers actuator and a solar panel for charges the energy storage device. At least one lift channel is provided which is capable of engaging with inversion fingers.

Yet another embodiment is provided in a method for handling waste comprising:
providing a compressing collection bin comprising a cavity; a compression platen in the cavity and positioned to move within the cavity to compress waste contained therein during a compression stroke; an actuator for moving the compression platen; an energy storage device for powering the actuator; a solar panel for charging said energy storage device; and at least one lift channel capable of engaging with inversion fingers; introducing waste to the cavity of the compressing collection bin; and
moving the compression platen within the cavity in at least one motion selected from perpendicular motion and differential velocity to reduce a volume containing the waste thereby compressing the waste.

Yet another embodiment is provided in a system for waste handling. The system comprises a compressing collection bin. The compressing collection bin comprises a platen hinge and a compression platen rotatably attached to the platen hinge. An actuator is provided for rotating the compression platen on the platen hinge wherein the rotation is within a cavity of the compressing collection bin.

Yet another embodiment is provided in a compressing collection bin for collecting waste wherein the compressing collection bin comprises a platen hinge and a compression platen rotatably attached to the platen hinge. An actuator is provided for rotating the compression platen on the platen hinge wherein the rotation is within a cavity of the compressing collection bin.

Yet another embodiment is provided in a method for handling waste comprising:
providing a compressing collection bin wherein he compressing collection bin comprises:
a platen hinge;
a compression platen rotatably attached to the platen hinge; and
an actuator for rotating the compression platen on the platen hinge wherein the rotation is within a cavity of the compressing collection bin;
introducing waste to a cavity of the compressing collection bin; and
rotating the compression platen on the platen hinge to reduce the volume containing the waste thereby compressing the waste.

### BRIEF DESCRIPTION OF THE FIGURES

FIG. 1 is a schematic perspective cut-away view of an embodiment of a compressing collection bin of the invention.

FIG. 2 is a schematic cross-sectional side view of an embodiment of a compressing collection bin of the invention.

FIG. 3 is a schematic cross-sectional view of an embodiment of a compressing collection bin of the invention.

FIG. 4 is a schematic cross-sectional side view of an embodiment of a compressing collection bin of the invention.

FIG. 5 is a schematic cross-sectional view an embodiment of a compressing collection bin of the invention.

FIG. 6 is a schematic side view of an embodiment of the system of the invention.

FIG. 7 is a schematic side view of an embodiment of the system of the invention.

FIG. 8 is a schematic cross-sectional view an embodiment of a compressing collection bin of the invention.

FIG. 9 is a schematic partial cut-away view of an embodiment of the invention.

FIG. 10 is a schematic cross-sectional to view of an embodiment of the invention.

FIGS. 11, 11A and 11B are schematic representations of an embodiment of the invention.

FIG. 12 is a schematic cross-sectional view of an embodiment of the invention.

### DESCRIPTION

The present invention is related to an improved waste handling system and an improved compressing collection bin suitable for use therewith. More specifically, the present invention is related to a waste handling system which improves cycle time thereby reducing cost. The invention also reduces traditional energy consumption which reduces cost and improves the environmental impact of the system.

The invention will be described with reference to the figures which are an integral, but non-limiting, part of the disclosure intended to clarify the invention without providing limits thereto. Throughout the figures similar elements will be numbered according.

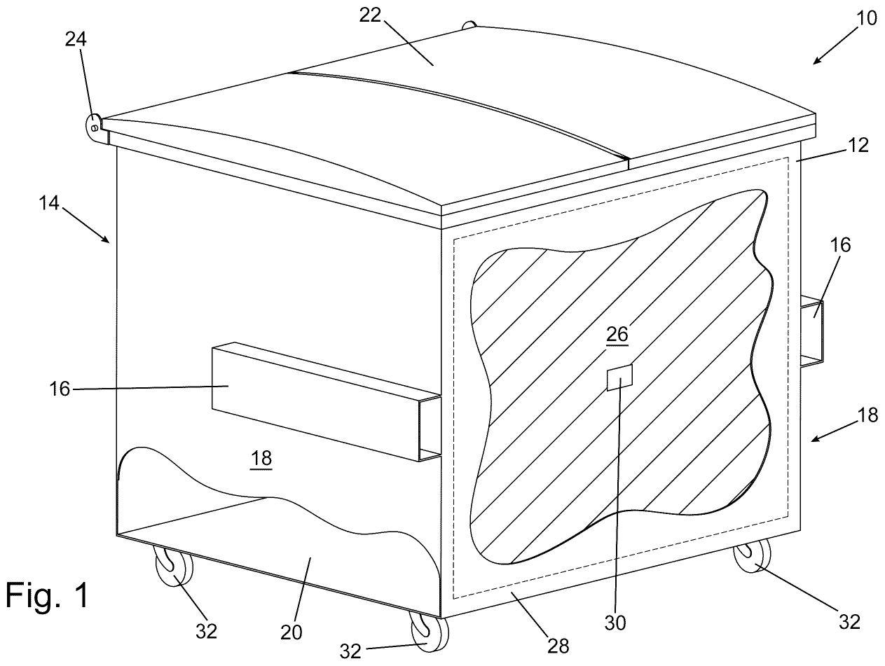

An embodiment of the invention will be described with reference to FIG. 1. In FIG. 1, a compressing collection bin, 10, is illustrated schematically in perspective partial cut-away view. The compressing collection bin comprises a front face, 12, and back face, 14, the relationship of which are defined for the purposes of clarity of the description and is not otherwise limiting. For the purposes of clarity, the front face and back face are approximately perpendicular to lift channels, 16, the purpose of which will be further described herein. The lift channels are attached to, or integral to, side faces, 18. The side faces, front face, bottom face and a bottom, 20, form a cavity within which waste is collected and contained. A top, 22, which could be a single element or multiple elements, provides a cover over the cavity. The top is preferably attached to the compressing collection bin by a top hinge, 24. A compression platen, 26, is rotationally attached to the interior of the compressing collection bin, by a platen hinge, 28. An actuator, 30, persuades the compression platen to rotate on the platen hinge with differential velocity thereby decreasing the volume of the compressing collection bin within which waste is contained, thereby compressing the waste as will be more fully described elsewhere herein. Optional, but preferred, wheels, 32, allow the compressing collection bin to be more easily moved.

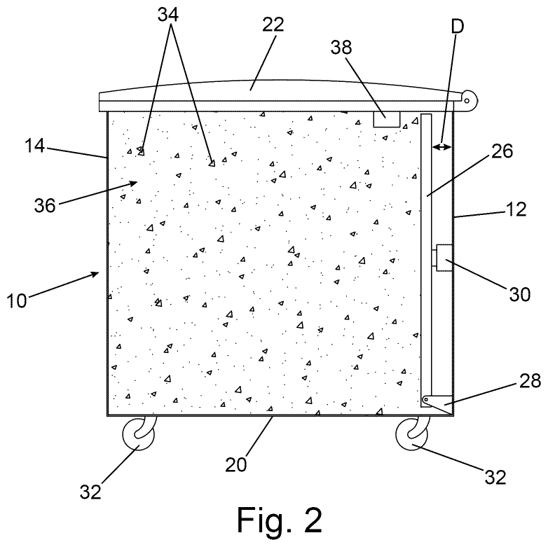

An embodiment of the operation of the compressing collection bin will be described with reference to FIGS. 2-4. FIG. 2 is a schematic cross-sectional side view of a compressing collection bin, 10, with waste, 34, contained within the cavity, 36. The cavity is defined as the area bound by the front face, 12, back face, 14, side faces, 18, bottom, 20, and top, 22. In FIG. 2, the compression platen is illustrated, for the purposes of discussion, to be within the cavity and adjacent to, and preferably parallel to, the front face. It is preferable that the distance, D, between the front face and compression platen be as small as possible since this limits the volume of the cavity occupied by the compression mechanism; defined as the compression platen, platen hinge, actuator, and other elements associated with movement of the compression platen. A volume sensor, 38, measures the accumulation of waste within the cavity. The function of the volume sensor will be further discussed herein. FIG. 2 illustrates the position of the compression platen prior to the action of compression.

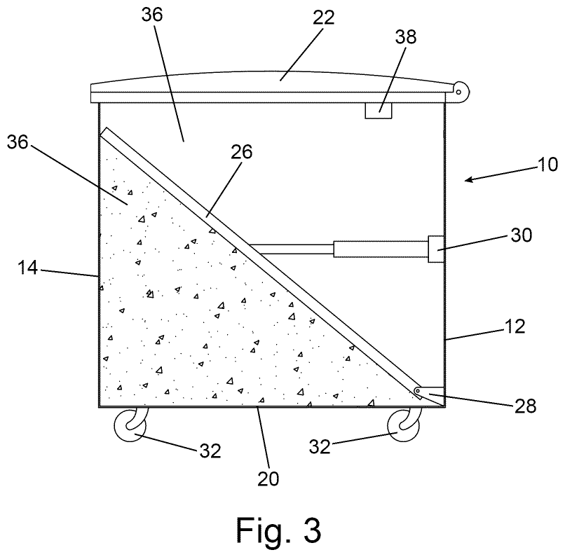

FIG. 3 is a schematic cross-sectional side view of the compressing collection bin of FIG. 2 after the actuator, 30, has persuaded the compression platen, 26, to pivot on the platen hinge, 28, thereby bifurcating the cavity, 36, into an empty region, between the compression platen and front face, and a compressed region, between the compression platen and back face in this embodiment without limit thereto. As would be realized the waste of FIG. 2 is within a smaller volume and compression and therefore the waste is has a higher density or weight per area volume.

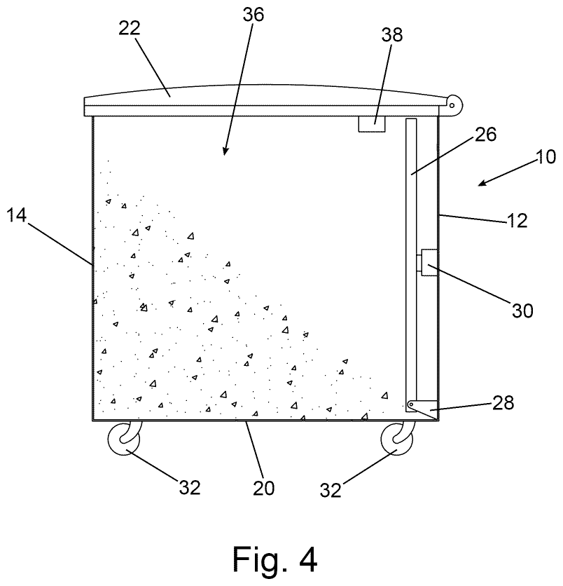

FIG. 4 is a schematic cross-sectional side view of the compressing collection bin of FIGS. 2 and 3 after the actuator, 30, has persuaded the compression platen, 26, to pivot on the platen hinge, 28, back to the original position thereby providing a vacancy within the cavity, 36, for additional waste to be added. The cycle of compression, as illustrated in FIG. 3, and retreat, as illustrated in FIG. 4, may be repeated many times depending on the amount and compressibility of the waste. In a preferred embodiment, the compression ratio, which is the ratio of the volume of compressed waste to the volume of the same amount of waste prior to compression, is at least 2 to 8, preferably at least 3, and more preferably at least 4. A compression ratio of above about 8 is difficult to achieve with most waste streams.

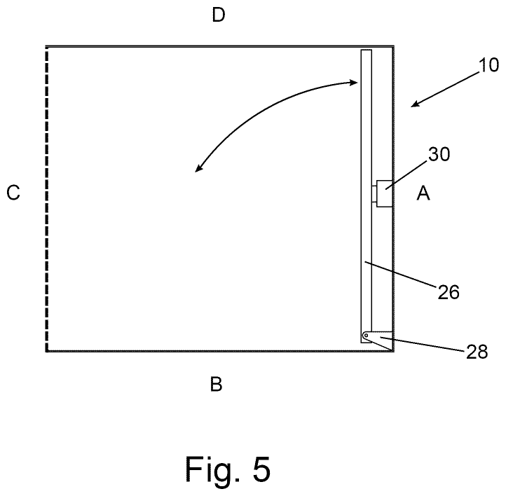

An embodiment of the invention will be described with reference to FIG. 5. In FIG. 5 a compressing collection bin, 10, is illustrated in schematic cross-sectional view. FIGS. 1-4 illustrated the compression platen, 26, as being adjacent to, and preferably parallel to, the from face for the purpose of clarity of the description. FIG. 5 illustrates other embodiments. In FIG. 5, Face A is the face with which the compression platen is adjacent to, and preferably parallel to. Face A, can be the front face, back face, or a side face. For the purposes of clarity, in the embodiment illustrated in FIGS. 1-4, Face A would correspond to the front face, Face B, would correspond to the bottom, Face C would correspond to the back face and D would represent the open top of the cavity. In another embodiment, Face A could be the back face and therefore Face B would be the bottom, Face C would be the front face and Face D would represent the open top of the cavity based. In another embodiment, Face A could be a side face and therefore Face B would be the bottom, Face C would be the opposing side face and D would represent the open top of the cavity. In another embodiment Face A and Face B could represent adjacent faces, such as the front face and a side face and the compression platen remains perpendicular to the bottom during compression.

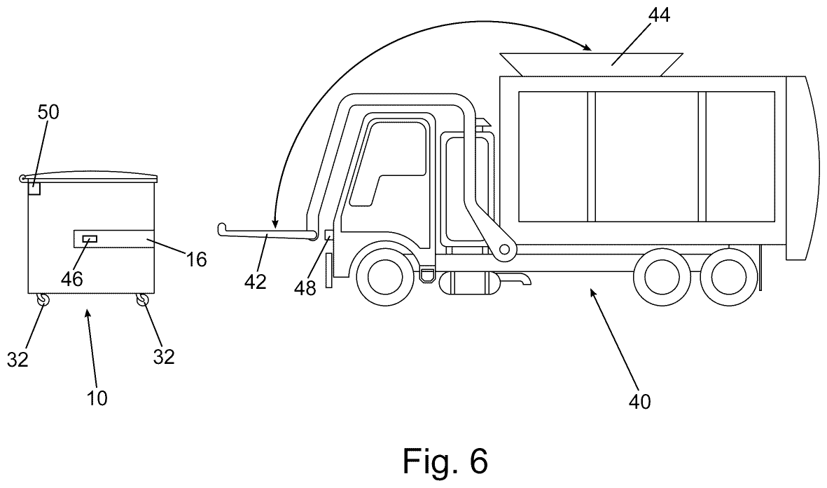

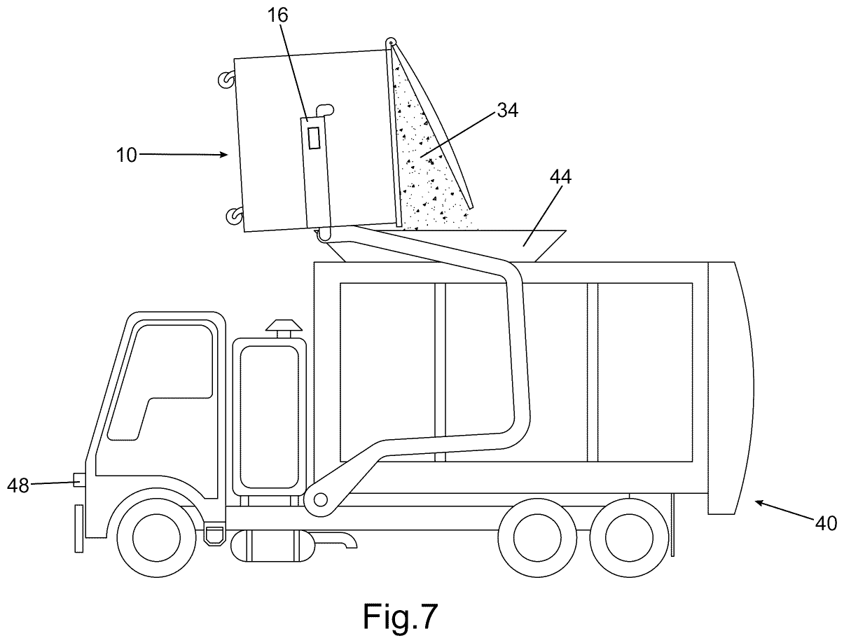

An embodiment of the invention will be described with reference to FIGS. 6 and 7. FIG. 6 is a schematic side view representation of an embodiment of the system of the invention. In FIG. 6, a compressing collection bin, 10, is illustrated schematically wherein the compressing collection bin comprises waste and preferably waste which is at least partially compressed. A transport vehicle, 40, is illustrated schematically wherein the transport vehicle comprises inversion fingers, 42, wherein the inversion fingers are capable of engaging with the lift channels, 16, of the compressing collection bin, 10. As illustrated in FIG. 7, the inversion fingers lift and invert the compressing collection bin over a hopper, 44, of the transport vehicle, 40, thereby allowing the waste, 34, to enter the hopper from the cavity of the compressing collection bin preferably by gravity assist. An optional but preferred bin sensor, 46, is capable of communication with an optional but preferred transport sensor, 48, the purpose of which will be further detailed herein. An optional but preferred lockout, 50, preferably communicates with at least one of the volume sensor or bin sensor as will be more fully described herein.

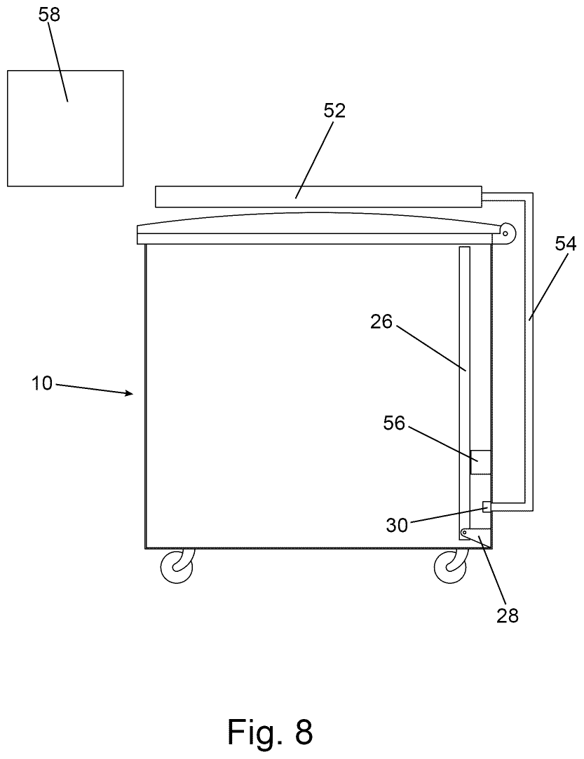

An embodiment of the invention will be described with reference to FIG. 8 wherein an embodiment of the invention is illustrated in schematic representation. The compressing collection bin, 10, comprising a compression platen, 26, and platen hinge, 28, as discussed elsewhere herein. The actuator, 30, receives power from a power source, 52, preferably through electrical conductors, 54, such as wire. An optional, but preferred, energy storage device, 56, such as a battery is provided wherein energy from the power source can be stored when not needed for use during the compression operation. An environmental component, 58, is optionally provided to alter or monitor the operating environment of the compressing collection bin. The environmental component is a component which alters or monitors the operating environment with particularly preferred environmental components including lights and cameras which can be either automatically activated, remotely activated or combinations thereof.

The size of the compressing collection bin, and material of construction is not particularly limited by the invention. Metal compressing collection bins are typically preferred due to the manner in which the compressing collection bins are used. Plastic, particularly reinforced plastic or resin, compressing collection bins are particularly suitable for demonstration of the invention. Compressing collection bins are sized for convenience and space constraints. While not limited by the invention, compressing collection binds of 1 to 6 cubic yard capacity are typically utilized with compressing collection bins of 2 cubic yards, 3 cubic yards of 4 cubic yards being most common. For the purposes of this invention the size is defined to be within 10% of that stated. By way of non-limiting example a 4 cubic yard compressing collection bin would refer to a compressing collection bin with a size of at least 3.6 cubic yards to no more than 4.4 cubic yards.

The top, and top hinge are not particularly limited by the invention. In an embodiment of the invention the top can be locked out to avoid unauthorized use. In a particular embodiment the bin sensor, which will be discussed further herein, can activate a locking mechanism which inhibits unauthorized opening of the bin or inhibits closing of the bin during the inversion process. It is particularly preferred that the locking mechanism inhibit the top from opening during the compression cycle.

The actuator can be a rotational actuator which rotationally or linearly persuades the compression platen to rotate on the platen hinge. The actuator can be integral to the platen hinge to cause rotation of mating components of the compression platen on the rotational axis defined by the platen hinge. Alternatively, the actuator can be separate from the platen hinge and attached to the compression platen and to a face of the compressing collection bin such that the actuator can extend, thereby rotating the compression platen towards a compression orientation as illustrated in FIG. 3, or retreat, thereby rotating the compression platen back to the non-compression orientation as illustrated in FIGS. 2 and 4.

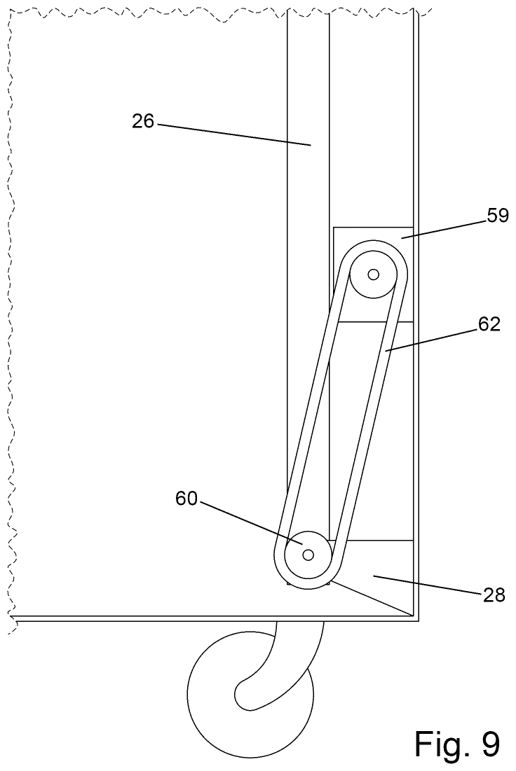

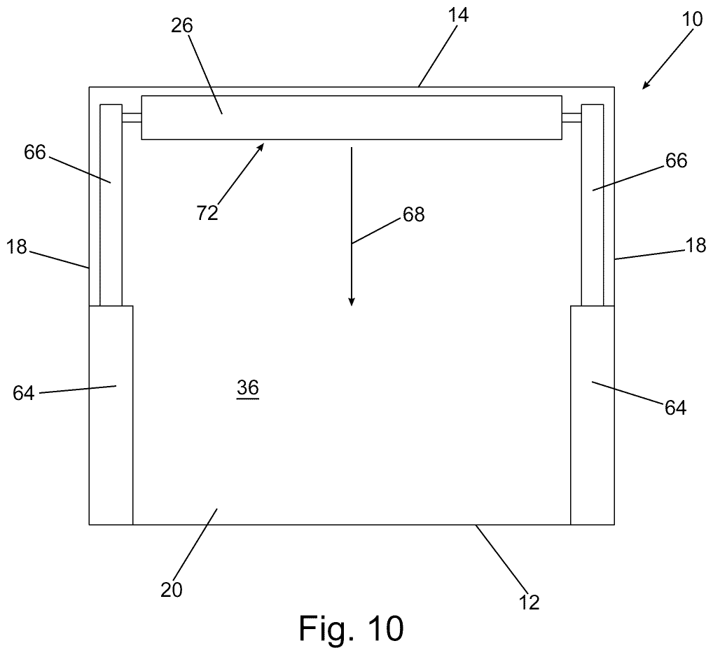

The actuator may comprise hydraulic activation such as with a piston, preferably a multi stage piston, extending from and retreating into a hydraulic cylinder. The actuator may comprise electrical activation wherein electrical energy activates a motor coupled to the compression platen by gears and belts or chains. The actuator may comprise electromagnetic activation wherein electromagnetic forces extend or retrieve a piston wherein the electromagnetic activation preferably comprises spring assist. The actuator may be a scissor comprising parallelograms. An embodiment of an actuator is illustrated in schematic partial cut-away view in FIG. 9. In FIG. 9 a motor, 59, is provided wherein the motor is rotationally linked to a wheel, 60, by a connector, 62, such as continuous belt, chain, gear or an equivalent. Rotation of the shaft of the motor causes the connector to engage with the wheel thereby causing the wheel to rotate. The platen hinge 28, is rotationally linked to the wheel and rotates in relation to the wheel. The compression platen, 26, moves on a rotational arc as described elsewhere herein. The motor may activate a single wheel or multiple wheels each attached to or integral to the platen hinge. The compressing platen may retract immediately upon completion of the compression stroke, or it may be delayed for a predetermined, or operator definable, period of time. Delaying the return of the compressing platen may increase density of the waste.

An embodiment of the invention is illustrated in schematic cross-sectional view in FIG. 10. In FIG. 10, the compressing collection bin, 10, is illustrated with a front face, 12, side faces, 18, back face, 14, and bottom forming the cavity, 36, wherein waste, not shown, is received. The compressing platen, 26, extends approximately parallel to the front face and back face and preferably from the bottom to the top, not shown in this view. Hydraulic linear actuators, comprising a hydraulic cylinder, 64, and associated ram, 66, function as the actuator. The ram is connected to the compression platen. Contrary to conventional usage of hydraulic linear actuators, the ram persuades the compression platen in a direction from the back face to the front face during the compression stroke, represented by arrow 68, and therefore the hydraulic linear actuator retracts during the compression stroke instead of extension during the compression stroke. As would be realized from the description a compression stroke is motion in the direction of trash compaction. It is well known in the art that the extension stroke is typically capable of providing higher pressure than the retraction stroke and therefore a compression stroke persuaded by retraction is contrary to the expectations of the skilled artisan. In FIG. 10 the compressing platen can move in along a path wherein the compression platen remains approximately perpendicular to the bottom, referred to herein as perpendicular motion. In perpendicular motion the velocity perpendicular to the face, 70, is approximately constant at all points of the face. In an alternative embodiment the compression platen can move with differential velocity defined herein as a movement wherein the top of the face, furthest from the bottom, moves at a different velocity than the bottom of the face, closest to the bottom. Preferably, the top of the face moves faster, having higher velocity, than the bottom thereby providing an increasing downward pressure with decreasing distance from the front face. While described is a compressing collection bin which compresses trash from back to front this is merely for the purposes of description with the understanding that compression can be from front to back or from side to side.

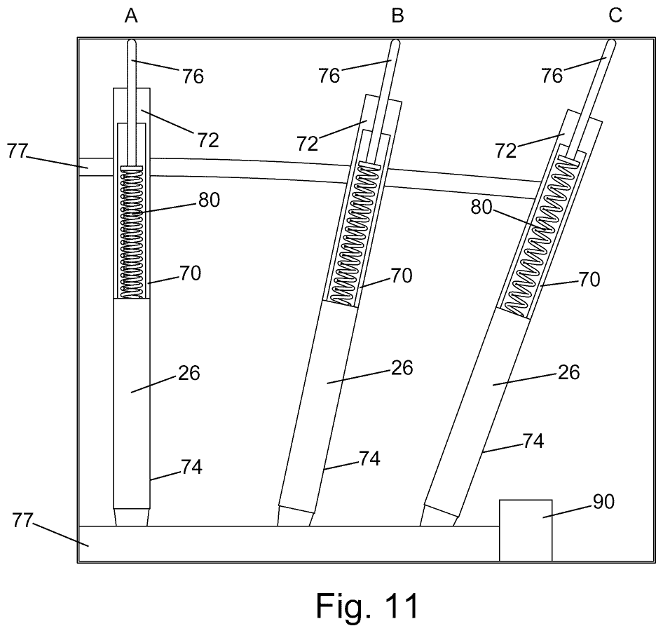

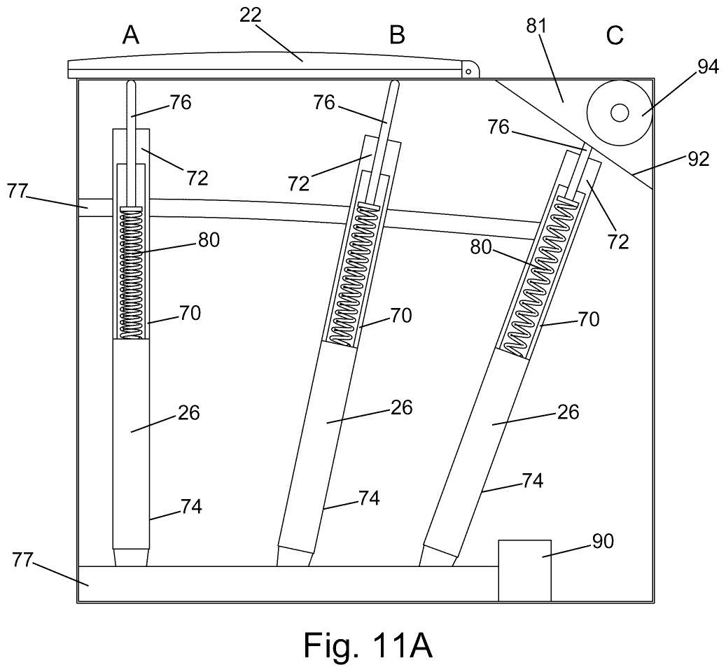

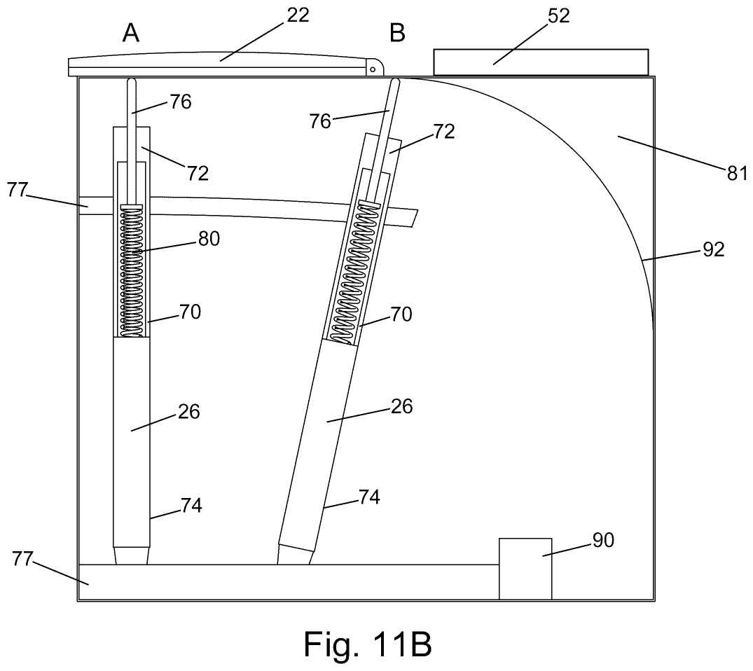

Differential velocity will be described with reference to FIG. 11 wherein a partial cross-sectional schematic view provided. In FIG. 11, the compression platen, 26, is illustrated in three different locations within the cavity represented by A, B and C. As the compression platen moves from initial position A, through intermediate position B and to terminal position C the top of the face, 72, moves forward at a higher velocity than the bottom of the face, 74. The differential velocity changes the angle of the compression platen relative to the bottom, 20. The differential velocity provides some downward force on the waste which minimizes waste matriculating upward in the cavity. Upper tracks, 77, and lower tracks, 79, guide the compression platen during the stroke and control the relative velocity such as by differential resistance. The shape of the upper tracks and lower tracks is not particularly limited herein with any shape capable of guiding the compression platen suitable for demonstration of the invention. Track and cavity shapes which inhibit trapping of waste therein are particularly preferred. In an embodiment the compression platen may have perpendicular motion for a portion of the movement from initial position to terminal position and a differential velocity thereafter. In an embodiment the compression platen may move in a manner consistent with perpendicular motion until the bottom is influenced by a fixed or flexible stop mechanism, 90, thereby decreasing the velocity of the bottom of the compression platen relative to the top of the compression platen. The stop mechanism may be a fixed element such as a metal stop or a flexible element such as a spring.

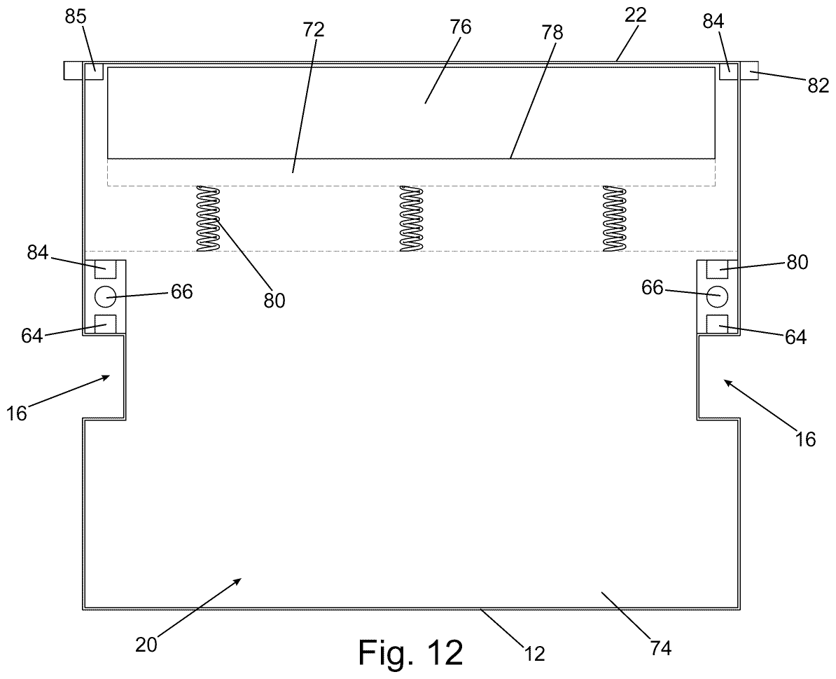

During differential motion, or a change in shape of the top of the compressing collection bin, the top of the compression platen may break contact with the top thereby allowing waste to enter the area vacated by the compression platen during the compression stroke to compress the waste. An embodiment of the invention is described with further reference to FIG. 12. In FIG. 12, an extendable wiper, 76, is illustrated wherein the extendable wiper is persuaded towards contact with the top, 22. In an embodiment, the extendable wiper is a flexible material which is persuaded towards a flexed position by pressure against the top. As the distance between the compression platen and top vary the flexible material is persuaded towards contact with the top. In an embodiment the extendable wiper is slidably received in a slot, 78, of the compression platen. Springs or the like, 80, persuade the extendable wiper towards the top.

Embodiments of the invention are discussed with reference to FIGS. 11A-B wherein cavity limiters are illustrated in cross-sectional schematic view. A cavity limiter, 92, reduces preferably a portion of the volume of the cavity and provides compression advantages. The cavity limiter is preferably a converging cavity limiter which decreases the interior height of the cavity in the compression direction. The cavity limiter limits the extension necessary by the extendable wiper, 76, during transit from position A to B to C. The cavity limiter may be a linear cavity limiter as in FIG. 11A, thereby forming a traditional notchback bin shape, or the cavity limiter may be an arcuate cavity limiter as in FIG. 11B. In an embodiment the cavity limiter may be a combination of a linear cavity limiter and an arcuate cavity limiter. As shown in FIG. 11B less, or even no, extendable wiper is required to prevent waste from escaping the compression region into the empty region over the top of the platen if the cavity converges arcuately with a radius matching the height of the platen. In another embodiment the wiper may not be flexible and may be a metal, Teflon, or plastic wiper that maintains contact with the top surface of the cavity. Further the cavity limiter forms a compartment, 81, which may contain functional components, 94, such as hydraulic pumps, motors, valves, batteries, controllers, maintenance equipment and other elements for which it is desirable to maintain in a separate area then the compressed waste.

An embodiment of the invention is illustrated in schematic cross-sectional view with further reference to FIG. 12. In FIG. 12, the lift channels, 16, extend into the cavity which increases the width of the compressing collection bin wherein the volume gained by the width increase is preferably larger than the interior area loss due to the lift channels being interior to the cavity. In FIG. 12, the extendable wiper, 76, is illustrated as being in contact with the top, 22. The top optionally and preferably comprises a rain drip edge, 82, which mitigates water entry into the cavity during adverse weather. Hydraulic reservoirs, 84, comprise hydraulic fluid which is exchanged with the cylinder to extend and retract the ram. The reservoir preferably comprises an invertible seal which allows air flow there through when upright but seals during inversion. An optional, but preferred, hydraulic assist, 85, associated with said top provides hydraulic persuasion to the opening operation of the top, 22, thereby allowing for a heavier top to be employed. If the top is too heavy it is difficult for some users to operate. A top that is too light does not adequately compress the waste upon closing and may remain partially open which is detrimental to the operation since weather and animals may enter the cavity. It is preferable to have a top having sufficient weight to close fully, with some compaction applied if necessary, yet easily opened by the user. Hydraulic assist facilitate the balance of weight and ease of use.

The volume sensor measures the volume of waste in the cavity and may include multiple sensors if desired. The volume sensor is preferably an optical sensor which determines if the waste has exceeded a predetermined height or width in the cavity. If the volume sensor indicates waste exceeding the predetermined height or width in the cavity several actions can occur. The volume sensor can relay a signal to the actuator thereby automatically causing the compression platen to compress the waste without additional input. In another embodiment the volume sensor can signal for a pickup by the transport vehicle. The location of the volume sensor is preferably coordinated with that portion of the waste which is vacated during the compression cycle as illustrated schematically in FIG. 4.

The hydraulic linear actuator is preferably a double action cylinder wherein extension and contraction are active. Single action cylinders are active in extension with the force for retraction provided by non-hydraulic pressure such as a spring.

The bin sensor and transport sensor preferably communicate to indicate a relationship between the transport vehicle and compressing collection bin. The transport sensor can be attached to or integral to the transport vehicle or the transport sensor can be a stand-alone sensor. Communication between the bin sensor and transport sensor can be physical wherein a portion of the transport vehicle engages with a mechanical switch wherein the mechanical switch interacts with the locking mechanism to allow for the top to open thereby allowing dumping of the waste. Communication may be by carrier wave at a given frequency. Communication can be by a conventional communication protocol such as Bluetooth. Communication can be by optical signals such as a laser. Communication can be by a proximity detector. Communication can be electromagnetic such as a radio frequency identification device.

The power source can be an AC power source or a DC power source. A particularly preferred power source is a solar panel. The solar panel can be attached to, or integral to a component of the compression collection bin. In an embodiment the power source is integral to the top as illustrated in FIG. 11B at 52 wherein the preferred power source is a solar panel.

The energy storing device is preferably a battery. Preferred batteries include lead-acid batteries and lithium-ion batteries. Lithium-ion batteries can be based on lithium oxides include nickel, manganese, cobalt, iron and other metals. Particularly suitable batteries comprise lithium nickel/manganese based cathodes or lithium iron phosphate cathodes.

The lift channels are not particularly limited herein. External lift channels; which are outside of the cavity can be employed as can internal lift channels which are internal to the cavity. The lift channels are dimensioned to receive the inversion fingers of the lift truck with sufficient structural integrity to lift the compressing collection bin and invert it as would be understood to those of skill in the art. The lift channels with a rectangular cross-section preferred without limit thereto. The lift channels can be of the bluderbuss style comprising a larger opening than the cross-sectional opening of the channel to provide a guide for inversion fingers.

The invention has been described with reference to the preferred embodiments without limit thereto. Other embodiments, alterations and improvements will be realized which are within the scope of the claims appended hereto.

1. A system for waste handling comprising:
a compressing collection bin wherein said compressing collection bin comprises:
a cavity;
a compression platen in said cavity and positioned to move within said cavity to compress waste contained therein during a compression stroke;
an actuator for moving said compression platen within said cavity in at least one motion selected from perpendicular motion and differential velocity;
an energy storage device for powering said actuator;
a solar panel for charging said energy storage device; and
at least one lift channel capable of engaging with inversion fingers.

2. The system for waste handling of claim 1 wherein said compression platen further comprises an extendable wiper.

3. The system for waste handling of claim 1 wherein said extendable wiper is slidably received in a slot in said compression platen.

4. The system for waste handling of claim 3 wherein said extendable wiper is persuaded towards a top on said cavity.

5. The system for waste handling of claim 4 wherein said extendable wiper is persuaded towards a top on said cavity by a spring.

6. The system for waste handling of claim 1 further comprising a top for said cavity and a hydraulic assist associated with said top.

7. The system for waste handling of claim 1 wherein said actuator comprises at least one hydraulic ram and associated hydraulic cylinder.

8. The system for waste handling of claim 1 further comprising at least one track capable of guiding said compression platen.

9. The system for waste handling of claim 1 further comprising a stop mechanism capable of stopping at least a portion of said compression platen.

10. The system for waste handling of claim 9 wherein said stop mechanism is selected from a fixed stop mechanism and a flexible stop mechanism.

11. The system for waste handling of claim 9 wherein said at least one hydraulic ram is retracted by said hydraulic cylinder during said compression stroke.

12. The system for waste handling of claim 9 further comprising a hydraulic reservoir capable of exchanged fluid with said cylinder to retract and extend said ram from hydraulic cylinder.

13. The system for waste handling of claim 1 further comprising a volume sensor capable of determining a waste volume in said compressing collection bin.

14. The system for waste handling of claim 13 wherein said volume sensor is in communication with said actuator and when said volume sensor detects said waste volume above a predetermined level said actuator moves said compression platen to compress said waste.

15. The system for waste handling of claim 14 wherein said volume sensor is in communication with said actuator and when said volume sensor detects said waste volume above a predetermined level volume sensor signals for a pickup by the transport vehicle.

16. The system for waste handling of claim 1 wherein said waste is compressed to a compression ratio at least 2 to no more than 8 during said compression stroke.

17. The system for waste handling of claim 16 wherein said compression ratio is at least 3.

18. The system for waste handling of claim 17 wherein said compression ratio is at least 4.

19. The system for waste handling of claim 1 wherein said energy storage device is a battery.

20. The system for waste handling of claim 1 further comprising an environmental component.

21. The system for waste handling of claim 20 wherein said environmental component is selected from a light and a camera.

22. The system for waste handling of claim 1 further comprising a transport vehicle.

23. The system for waste handling of claim 22 wherein said transport vehicle comprises at least one inversion finger.

24. The system for waste handling of claim 23 at least one said at least one inversion finger is received by received by said at least one lift channel for inversion of said compressing collection bin over a hopper of said transport vehicle.

25. The system for waste handling of claim 22 comprising a bin sensor in communication with a transport sensor.

26. The system for waste handling of claim 1 wherein said compressing collection bin has a volume of 1 to 6 cubic yards.

27. The system for waste handling of claim 26 wherein said compressing collection bin has a volume of 2 cubic yards, 3 cubic yards or 4 cubic yards.

28. The system for waste handling of claim 1 wherein said compressing collection bin further comprises:
a platen hinge wherein said compression is platen rotatably attached to said platen hinge; and
said actuator rotates said compression platen on said platen hinge.

29. The system for handling waste of claim 1 wherein said compression platen and said actuator are within said cavity of said compressing collection bin.

30. The system for waste handling of claim 1 wherein said compressing collection bin further comprises a cavity limiter.

31. The system for handling waste of claim 30 wherein said cavity limiter comprises at least one cavity limiter selected from the group consisting of a linear cavity limiter and an arcuate cavity limiter.

32. A method for handling waste comprising:
providing a compressing collection bin wherein said compressing collection bin comprises:
a cavity;
a compression platen in said cavity and positioned to move within said cavity to compress waste contained therein during a compression stroke;
an actuator for moving said compression platen;
an energy storage device for powering said actuator;
a solar panel for charging said energy storage device; and
at least one lift channel capable of engaging with inversion fingers;
introducing waste to a cavity of said compressing collection bin; and
moving said compression platen within said cavity in at least one motion selected from perpendicular motion and differential velocity to reduce a volume containing said waste thereby compressing said waste.

33-62. (canceled)
